(19) United States
(12) Patent Application Publication
(10) Pub. No.: US 2018/0234315 A1
(43) Pub. Date: Aug. 16, 2018

(54) DATA DIVISION UNIT, COMMUNICATION DEVICE, COMMUNICATION SYSTEM, DATA DIVISION METHOD, AND STORAGE MEDIUM HAVING DATA DIVISION PROGRAM STORED THEREIN

(71) Applicant: NEC CORPORATION, Tokyo (JP)

(72) Inventor: Atsushi ARITOME, Tokyo (JP)

(73) Assignee: NEC CORPORATION, Tokyo (JP)

(21) Appl. No.: 15/750,543

(22) PCT Filed: Aug. 1, 2016
(86) PCT No.: PCT/JP2016/003535

§ 371 Date: Feb. 6, 2018

(30) Foreign Application Priority Data
Aug. 7, 2015 (JP) 2015-157121

(51) Int. Cl. H04L 12/26; H04L 5/14

(52) U.S. Cl. CPC H04L 43/0852; H04L 5/14

(57) ABSTRACT

[Problem] To provide: a division unit in which a reception side can restore, to the original data, data that has been divided and transmitted by a transmission side and received via different transmission lines; a communication device; a communication system; a data division method; and a data division program. [Solution] A data division unit 200 comprising a division part 300. Depending on a plurality of transmission lines that run parallel to each other, the division part 300 divides data into divided data with lengths that correspond to the respective delay times of each of the plurality of transmission lines, and inputs the divided data into a communication tool that transmits transmission data, which is based on the divided data, according to the transmission lines.

### TECHNICAL FIELD

The present invention relates to a data division unit and a communication device that perform data communication, a communication system, a data division method, and a data division program.

### BACKGROUND ART

A wireless communication system is known in which wireless communication devices transmit and receive data, via each of a plurality of wireless transmission lines parallel to each other. In such a wireless communication system, the transmitting end determines a frame length to be transmitted through the wireless transmission line, on the basis of the transmission rate of each wireless transmission line. Then the transmitting end divides the data according to the frame length determined, and transmits the divided data through each wireless transmission line.

Under the mentioned arrangement, adjustment is made so that the receiving end receives the data through each of the wireless transmission lines, at the same time. Then the receiving end restores the divided data into the original data.

Patent Literature (PTL) 1 discloses a method by which, in a communication system for transmitting and receiving data using variable time division duplex (TDD), a communication apparatus divides the data to be transmitted according to an amount of the data to be transmitted and an amount of data to be transmitted from a counterpart communication apparatus, notified therefrom.

PTL 2 discloses a method of dividing data when a MAC frame longer than a predetermined length is received, and transferring the divided data.

### CITATION LIST

### Patent Literature

[PTL 1] Japanese Unexamined Patent Application Publication No. 2007-49450

[PTL 2] Japanese Unexamined Patent Application Publication No. 2005-12381

### SUMMARY OF INVENTION

### Technical Problem

However, the delay time of the data transmitted through each wireless transmission line differs from each other, depending on characteristics of the wireless communication device, a length of the communication cable employed, an impact of weather, and so forth. Accordingly, the receiving end may fail to properly restore the divided data that has been transmitted into the original data, because the transmission is performed taking only the transmission rate of each wireless transmission line, into account.

Neither the technique according to PTL 1 nor the technique according to PTL 2 provides a solution to the mentioned problem.

Accordingly, the present invention provides a division unit capable of restoring data divided and transmitted by a transmitting end, and received by a receiving end through different transmission lines, into original data, a communication device, a communication system, a data division method, and a data division program.

### Solution to Problem

A data division unit, according to the present invention, comprises dividing means that divides data, for each of a plurality of transmission lines parallel to each other, into divided data each having a length determined according to a delay time of a corresponding one of the plurality of transmission lines, and inputs transmission data based on the divided data to communication means for transmission, so as to correspond to the transmission lines.

A communication device, according to the present invention, comprises:

the data division unit according to any one of aspects; and

the communication means.

A communication system, according to the present invention, comprises:

the communication device according to any one of aspects; and

the receiving-end apparatus,

wherein the receiving-end apparatus includes:

receiving means that receives transmission data transmitted by the communication means; and

restoring means that restores the transmission data received by the receiving means, into the data.

A data division method, according to the present invention, comprises:

dividing data, for each of a plurality of transmission lines parallel to each other, into divided data each having a length determined according to a delay time of a corresponding one of the plurality of transmission lines; and

inputting transmission data based on the divided data to communication means for transmission, so as to correspond to the transmission lines.

A data division program, according to the present invention, for causing a computer to:

divide data, for each of a plurality of transmission lines parallel to each other, into divided data each having a length determined according to a delay time of a corresponding one of the plurality of transmission lines; and

input transmission data based on the divided data to communication means for transmission, so as to correspond to the transmission lines.

### Advantageous Effects of Invention

The foregoing configuration allows the data divided and transmitted by the transmitting end, and received by the receiving end through different transmission lines, to be restored into the original data.

### BRIEF DESCRIPTION OF DRAWINGS

FIG. 1 is a block diagram showing a configuration of a communication system according to a first example embodiment of the present invention.

FIG. 2 is a sequence chart for explaining a process of determining a length of a payload portion of a fragmentation signal, according to a delay time of each wireless transmission line.

FIG. 3 is a schematic diagram for explaining examples of delay time measurement frames.

FIG. 4 is a schematic diagram for explaining the length of the delay time measurement frame.

FIG. 5 is a sequence chart showing a transmission and reception process of a wireless frame between a transmitting-end communication device and a receiving-end communication device.

FIG. 6 is a schematic diagram for explaining a process of converting an Ethernet signal into an encapsulated signal, performed by an encapsulation block unit.

FIG. 7 is a schematic diagram for explaining a process of dividing the encapsulated signal to generate fragmentation signals, performed by a division and measurement unit.

FIG. 8A is a schematic diagram for explaining a process of restoring the encapsulated signal from the fragmentation signals.

FIG. 8B is another schematic diagram for explaining a process of restoring the encapsulated signal from the fragmentation signals.

FIG. 8C is another schematic diagram for explaining a process of restoring the encapsulated signal from the fragmentation signals.

FIG. 9 is a schematic diagram for explaining a process of decapsulating the encapsulated signal into the Ethernet signal.

FIG. 10 is a block diagram showing a configuration of a data division unit according to a second example embodiment of the present invention.

### DESCRIPTION OF EMBODIMENTS

### Example Embodiment 1

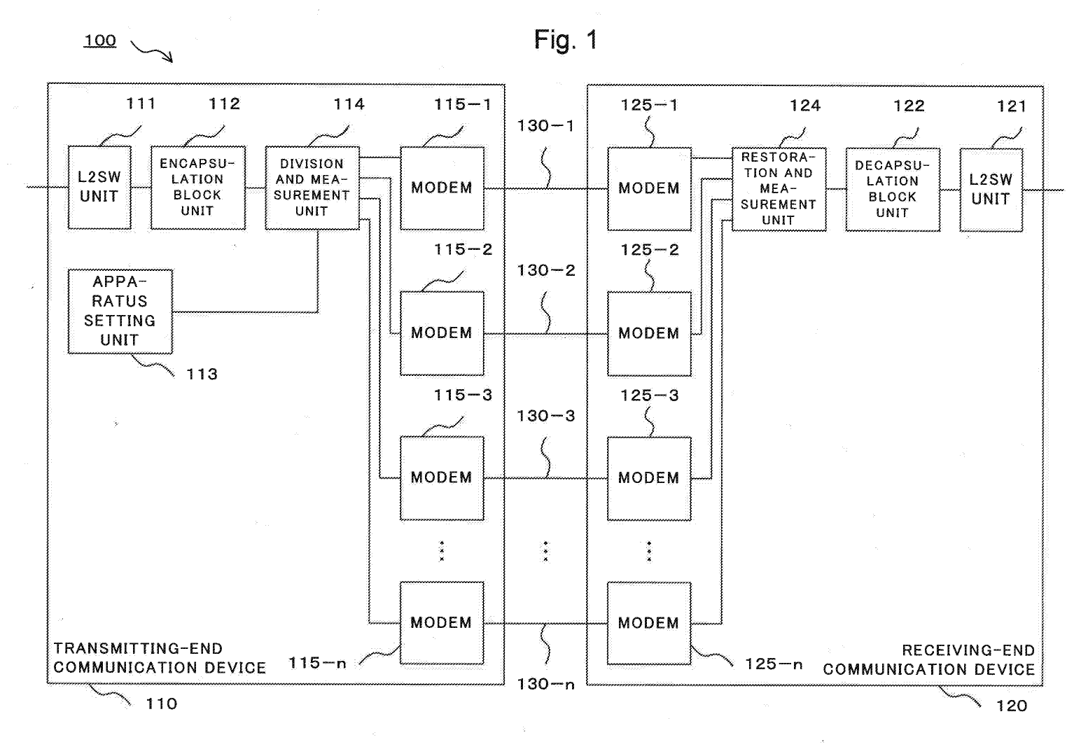

A communication system 100 according to a first example embodiment of the present invention will be described with reference to the drawings. FIG. 1 is a block diagram showing a configuration of the communication system 100 according to the first example embodiment of the present invention. As shown in FIG. 1, the communication system 100 according to the first example embodiment of the present invention includes a transmitting-end communication device 110 and a receiving-end communication device 120. The receiving-end communication device 120 receives, through each of the wireless transmission lines 130-1 to 130-n, a wireless frame transmitted by the transmitting-end communication device 110.

Here, although the wireless transmission lines 130-1 to 130-n are aligned in parallel between the receiving-end communication device 120 and the transmitting-end communication device 110, it will be assumed that the paths may differ, for example, owing to reflection.

As shown in FIG. 1, the transmitting-end communication device 110 includes a layer-2 switch (hereinafter, L2SW) unit 111, an encapsulation block unit 112, an apparatus setting unit 113, a division and measurement unit 114, and modems 115-1 to 115-n.

The L2SW unit 111 receives an Ethernet (registered trademark) signal, for example through a non-illustrated network. Then, the L2SW unit 111 inputs the received Ethernet signal to the encapsulation block unit 112.

The encapsulation block unit 112 converts the Ethernet signal inputted by the L2SW unit 111 into an encapsulated signal of a fixed length X. Then, the encapsulation block unit 112 inputs the converted encapsulated signal to the division and measurement unit 114.

In the apparatus setting unit 113, bandwidth information and division number setting information are registered.

The bandwidth information refers to information indicating the bandwidth of each of the wireless transmission lines 130-1 to 130-n, for example based on channel separation specified by the manager of the transmitting-end communication device 110, or determined by a wireless communication setting, such as a modulation format. Note that although in this example embodiment a single piece of bandwidth information provides the bandwidths of the respective wireless transmission lines 130-1 to 130-n, the bandwidth information indicating the bandwidth of one of the wireless transmission lines 130-1 to 130-n may be prepared for each of the wireless transmission lines 130-1 to 130-n.

The division number setting information refers to the information indicating the number of wireless transmission lines to be utilized, out of the wireless transmission lines 130-1 to 130-n, determined, for example, by the manager of the transmitting-end communication device 110.

The apparatus setting unit 113 inputs the bandwidth information and the division number setting information registered therein, to the division and measurement unit 114.

The division and measurement unit 114 measures a delay time of one or more of the wireless transmission lines 130-1 to 130-n, on the basis of the bandwidth information and the division number setting information, inputted by the apparatus setting unit 113. Then the division and measurement unit 114 divides the encapsulated signal inputted by the encapsulation block unit 112, according to the measurement result of the delay time, and generates a fragmentation signal. The division and measurement unit 114 inputs the fragmentation signal to one or more of the modems 115-1 to 115-n, on the basis of the bandwidth information and the division number setting information inputted by the apparatus setting unit 113.

The modems 115-1 to 115-n each modulate the fragmentation signal inputted by the division and measurement unit 114 into a wireless frame, so as to accord with the corresponding one of the wireless transmission lines 130-1 to 130-n. Then the modems 115-1 to 115-n each transmit the modulated wireless frame.

In addition, the modems 115-1 to 115-n each modulate a delay time measurement frame, used for measuring the delay time of the wireless transmission lines 130-1 to 130-n, so as to accord with the corresponding one of the wireless transmission lines 130-1 to 130-n, and transmits the modulated wireless frame.

As shown in FIG. 1, the receiving-end communication device 120 includes a L2SW unit 121, a decapsulation block unit 122, a restoration and measurement unit 124, and modems 125-1 to 125-n.

The modems 125-1 to 125-n respectively receive the wireless frames transmitted by the modems 115-1 to 115-n of the transmitting-end communication device 110, through the wireless transmission lines 130-1 to 130-n. Then the modems 125-1 to 125-n each demodulate the wireless frame received through one of the wireless transmission lines 130-1 to 130-n, and input the demodulated fragmentation signal to the restoration and measurement unit 124.

In addition, the modems 125-1 to 125-n each modulate the delay time measurement frame inputted by the restoration and measurement unit 124, so as to accord with the corresponding one of the wireless transmission lines 130-1 to 130-n, and transmits the modulated wireless frame.

The restoration and measurement unit 124 inputs the delay time measurement frames inputted by the modems 125-1 to 125-n, to the corresponding modems 125-1 to 125-n.

In addition, the restoration and measurement unit 124 restores the fragmentation signal inputted by the modems 125-1 to 125-n into the encapsulated signal. Then the restoration and measurement unit 124 inputs the restored encapsulated signal to the decapsulation block unit 122.

The decapsulation block unit 122 decapsulates the encapsulated signal inputted by the restoration and measurement unit 124 into the Ethernet signal. Then the decapsulation block unit 122 inputs the decapsulated Ethernet signal to the L2SW unit 121.

The L2SW unit 121 transmits the Ethernet signal inputted by the decapsulation block unit 122, for example to a non-illustrated communication apparatus located outside the communication system 100.

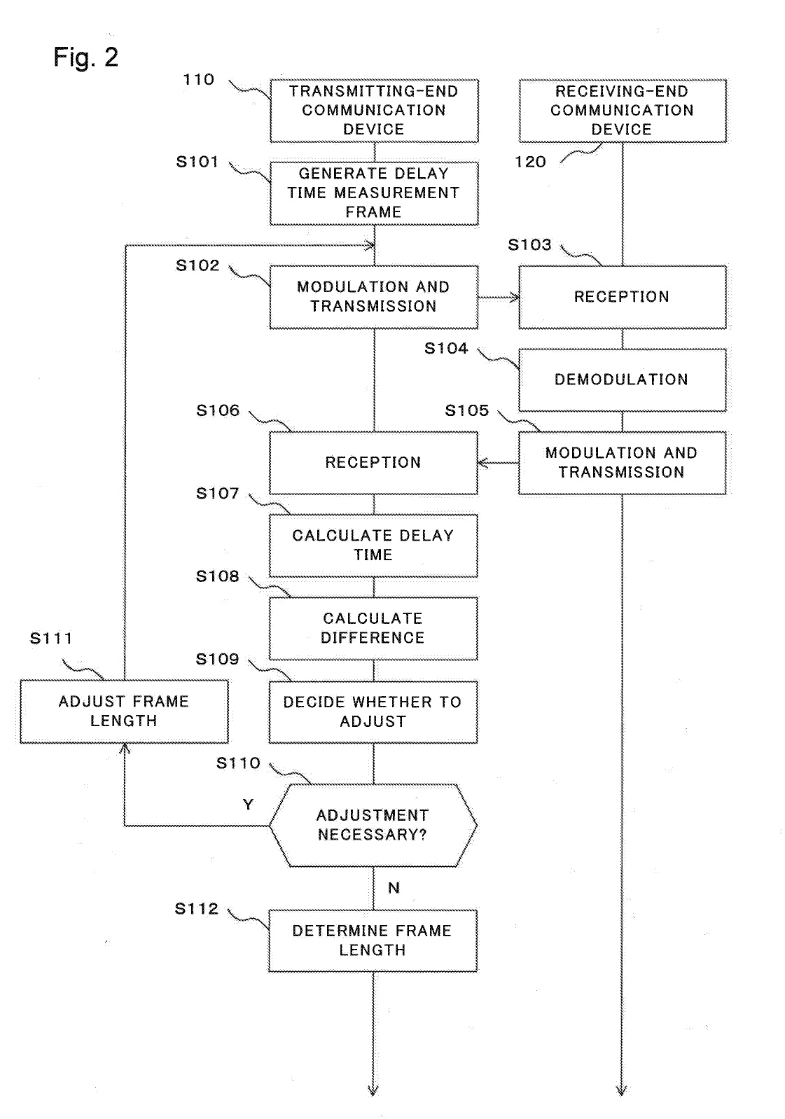

Hereunder, a method of determining the length of a payload portion of the fragmentation signal, according to the delay time of the wireless transmission lines 130-1 to 130-n, will be described. FIG. 2 is a sequence chart for explaining the process of determining the length of the payload portion of the fragmentation signal, according to the delay time of each of the wireless transmission lines 130-1 to 130-n.

The division and measurement unit 114 generates the delay time measurement frame, at a predetermined timing to measure the delay time (step S101). Here, the predetermined timing to measure the delay time refers to, for example, a timing at which the communication setting of the transmitting-end communication device 110 is made by the manager thereof and the link with the receiving-end communication device 120 is established, another specified timing, or a timing based on a predetermined time interval.

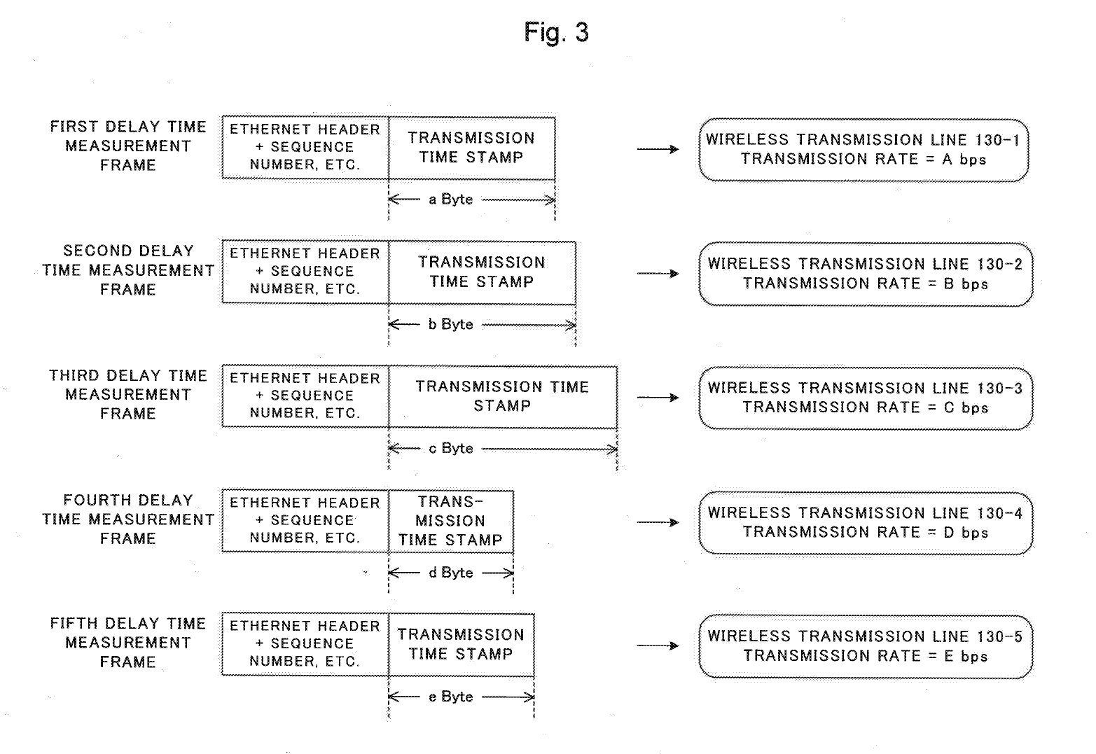

The delay time measurement frame generated by the division and measurement unit 114 will be described hereunder. FIG. 3 is a schematic diagram for explaining examples of the delay time measurement frames. For the purpose of explanation, it will be assumed that the division number setting information inputted by the apparatus setting unit 113 to the division and measurement unit 114 is indicating “5”. It will also be assumed that the bandwidth information inputted by the apparatus setting unit 113 to the division and measurement unit 114 indicates that the bandwidths (transmission rates) of the wireless transmission lines 130-1 to 130-5 are A to E bps, respectively. In this case, the division and measurement unit 114 generates first to fifth delay time measurement frames at step S101 as shown in FIG. 3, according to the number indicated by the division number setting information and the transmission rate indicated by the bandwidth information.

More specifically, the division and measurement unit 114 generates the first to the fifth delay time measurement frames, each including a header portion and a payload portion. Here, the respective header portions of the first to the fifth delay time measurement frames include an Ethernet header and information of, for example, a sequence number based on the sequence of the transmission. Further, the respective payload portions of the first to the fifth delay time measurement frames include a transmission time stamp indicating the time, or date and time of the transmission, with the indication of the frame lengths, which are a to e Byte, respectively.

Then, the division and measurement unit 114 generates the first to the fifth delay time measurement frames, such that the following equations are established:

a:b:c:d:e=A:B:C:D:E (1);and

a+b+c+d+e=fixed length X of encapsulated signal (2).

In this example embodiment, the values of the bandwidth (transmission rate) of the wireless transmission lines 130-1 to 130-5, namely A to E, are set in descending order of C, B, A, E, and D. In this case, the values of the frame length of the payload portion of the first to the fifth delay time measurement frames are set in descending order of c, b, a, e, and d. Therefore, the division and measurement unit 114 generates the delay time measurement frames so as to set the frame lengths in descending order of the third delay time measurement frame, the second delay time measurement frame, the first delay time measurement frame, the fifth delay time measurement frame, and the fourth delay time measurement frame.

The division and measurement unit 114 inputs the first to the fifth delay time measurement frames, generated at step S101, to the modems 115-1 to 115-5 respectively corresponding to the wireless transmission lines 130-1 to 130-5.

Note that various methods may be adopted to select, out of the wireless transmission lines 130-1 to 130-n, the wireless transmission lines corresponding to the value indicated by the division number setting information (in this example embodiment, five), through which the division and measurement unit 114 transmits the delay measurement frames. Specifically, the division and measurement unit 114 may be configured, for example, to generate the delay measurement frames for measuring the delay time, with respect to the wireless transmission lines up to the number indicated by the division number setting information (in this example embodiment, five) in descending order of the transmission rate indicated by the bandwidth information, out of the wireless transmission lines 130-1 to 130-n. Alternatively, the division and measurement unit 114 may be configured to generate the delay measurement frames for measuring the delay time, with respect to the wireless transmission lines up to the number indicated by the division number setting information in descending order of the transmission rate, out of the wireless transmission lines that are not currently in use. The mentioned methods allow the wireless transmission lines of higher transmission rates to be utilized with higher priority.

In addition, the division and measurement unit 114 may be configured to generate, at step S101, the first to the fifth delay time measurement frames all having the same frame length, according to the number indicated by the division number setting information.

The modems 115-1 to 115-5 respectively modulate the first to the fifth delay time measurement frames inputted by the division and measurement unit 114, and transmit the modulated wireless frames (step S102).

The wireless frames transmitted by the modems 115-1 to 115-5 are respectively received by the modems 125-1 to 125-5 of the receiving-end communication device 120, through the wireless transmission lines 130-1 to 130-5 (step S103).

Upon receipt of the wireless frame transmitted by the modems 115-1 to 115-5, the modems 125-1 to 125-5 of the receiving-end communication device 120 demodulate the wireless frames received, into the first to the fifth delay time measurement frames, respectively (step S104). Then the modems 125-1 to 125-5 respectively input the first to the fifth delay time measurement frames that have been demodulated, to the restoration and measurement unit 124.

Upon receipt of the first to the fifth delay time measurement frames, the restoration and measurement unit 124 inputs the first to the fifth delay time measurement frames to the respectively corresponding modems 125-1 to 125-5, from which the delay time measurement frames have been inputted. Note that, at this point, the restoration and measurement unit 124 does not change the transmission time stamp included in the payload portion of each of the first to the fifth delay time measurement frames.

The modems 125-1 to 125-5 respectively modulate the first to the fifth delay time measurement frames inputted by the restoration and measurement unit 124 into the wireless frames, and transmits the modulated wireless frames (step S105).

The modems 115-1 to 115-5 of the transmitting-end communication device 110 respectively receive the wireless frames transmitted by the modem 125-1 to 125-5, through the wireless transmission lines 130-1 to 130-5 (step S106).

The modems 115-1 to 115-5 respectively demodulate the wireless frames received through the wireless transmission lines 130-1 to 130-5 into the first to the fifth delay time measurement frames, and input the first to the fifth delay time measurement frames to the division and measurement unit 114. Then, the division and measurement unit 114 calculates the delay time of the wireless transmission lines 130-1 to 130-5, on the basis of the transmission timing and the current date and time (corresponding to the reception timing) indicated by the transmission time stamp included in the payload portion of the first to the fifth delay time measurement frames, respectively inputted by the modems 115-1 to 115-5 (step S107). Here, the division and measurement unit 114 calculates, as the delay time of the wireless transmission lines 130-1 to 130-5, for example a half of the time corresponding to the time difference between the date and time indicated by the transmission time stamp of each of the first to the fifth delay time measurement frames and the current date and time.

Then the division and measurement unit 114 calculates the difference among the respective delay times of the wireless transmission lines 130-1 to 130-5 calculated at step S107 (step S108).

The division and measurement unit 114 decides whether the frame length has to be adjusted, depending on whether the difference calculated at step S108 is equal to or smaller than a predetermined permissible difference (step S109). Here, it will be assumed that the predetermined permissible difference is registered in advance in the receiving-end communication device 120 on the basis of, for example, the capacity of a buffer provided in the restoration and measurement unit 124 of the receiving-end communication device 120, for absorbing a difference in arrival timing of the wireless frames originating from the difference in delay time among the wireless transmission lines 130-1 to 130-n.

In the case where the difference calculated at step S108 is equal to or smaller than the predetermined permissible difference, the division and measurement unit 114 decides that there is no need to adjust the frame length (N at step S110). Then the division and measurement unit 114 determines the length of the payload portion of the fragmentation signals respectively received through the wireless transmission lines 130-1 to 130-5, according to the length of the first to the fifth delay time measurement frames generated at step S101 (step S112), and thus finishes the process of determining the length of the payload portion of the fragmentation signals.

Further, in the case where the difference calculated at step S108 is larger than the predetermined permissible difference, the division and measurement unit 114 decides that the frame length has to be adjusted (Y at step S110).

Then the division and measurement unit 114 adjusts the length of the first to the fifth delay time measurement frames (step S111), and returns to the process of step S102.

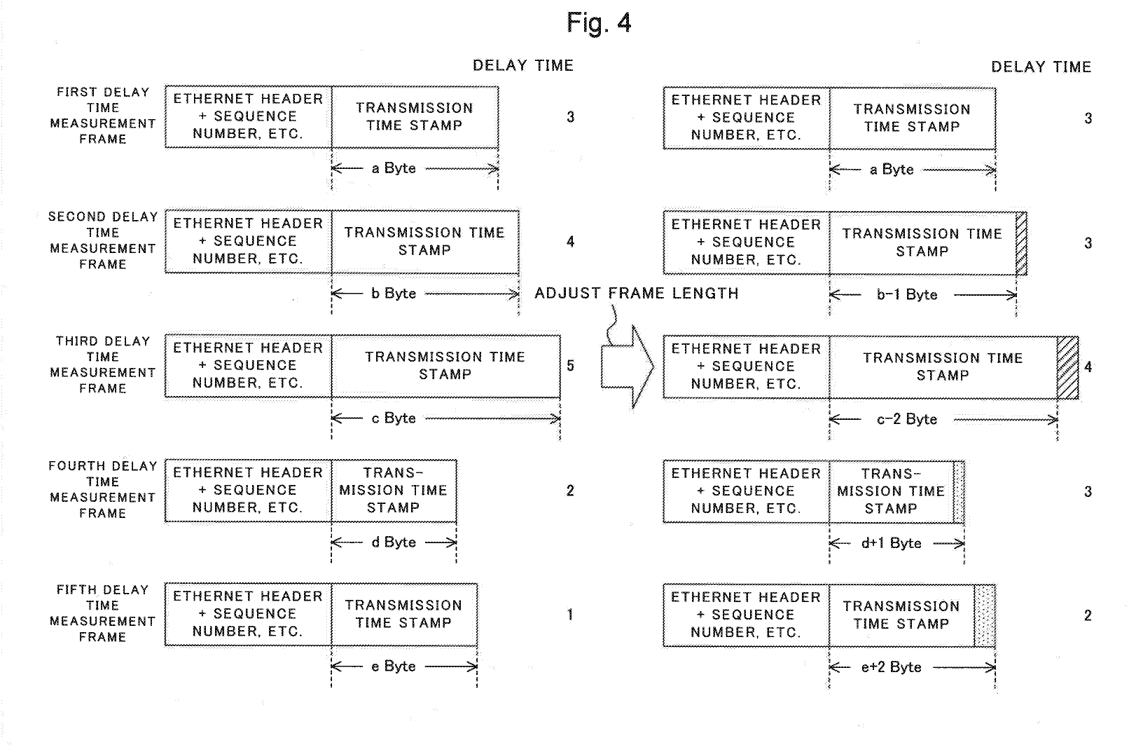

FIG. 4 is a schematic diagram for explaining the length of the delay time measurement frame. As shown in the left-hand section of FIG. 4, in this example embodiment it will be assumed that the delay time of the first delay time measurement frame, calculated at step S107, is 3, the delay time of the second delay time measurement frame is 4, the delay time of the third delay time measurement frame is 5, the delay time of the fourth delay time measurement frame is 2, and the delay time of the fifth delay time measurement frame is 1. This means that the delay time of the wireless transmission line 130-1 is 3, the delay time of the wireless transmission line 130-2 is 4, the delay time of the wireless transmission line 130-3 is 5, the delay time of the wireless transmission line 130-4 is 2, and the delay time of the wireless transmission line 130-5 is 1. Note that, in this example embodiment, the respective delay times of the first to the fourth delay time measurement frame (or wireless transmission lines 130-1 to 130-4) are indicated by the ratio to the delay time of the fifth delay time measurement frame (or wireless transmission line 130-5) which is the smallest, when the delay time of the fifth delay time measurement frame is represented by 1.

Now, the maximum value of the difference in delay time in this example embodiment is 4, between the delay time 5 of the third delay time measurement frame and the delay time 1 of the fifth delay time measurement frame. In addition, assuming that the predetermined permissible difference is 3 in this example embodiment, the maximum value of the difference in delay time in this example embodiment is larger than the predetermined permissible difference.

In this case (Y at step S110), at step S111, the division and measurement unit 114 reduces, for example, the frame length of the payload portion of the third delay time measurement frame having the largest delay amount by 2 Bytes, thus shortening to c−2 Byte, and reduces the frame length of the payload portion of the second delay time measurement frame having the second largest delay amount by 1 Bytes, thus shortening to b−1 Byte. In addition, at step S111 the division and measurement unit 114 increases, for example, the frame length of the payload portion of the fifth delay time measurement frame having the smallest delay amount by 2 Bytes, thus extending to e+2 Byte, and increases the frame length of the payload portion of the fourth delay time measurement frame having the second smallest delay amount by 1 Bytes, thus extending to d+1 Byte. Further, the division and measurement unit 114 updates the transmission time stamp stored in the payload portion to the value corresponding to the current date and time.

Then the division and measurement unit 114 generates the first to the fifth delay time measurement frames reflecting the adjustment of the frame length of the payload portion made at step S111, and inputs the delay time measurement frames thus generated to the respectively corresponding modems 115-1 to 115-5, after which the division and measurement unit 114 returns to step S102. Accordingly, the first to the fifth delay time measurement frames with the adjusted frame length are transmitted and received between the transmitting-end communication device 110 and the receiving-end communication device 120, and the respective delay times of the wireless transmission lines 130-1 to 130-5 are calculated.

Thus, the frame lengths of the payload portion of the first to the fifth delay time measurement frames are adjusted, until the difference in delay time among the wireless transmission lines 130-1 to 130-5 becomes equal to or smaller than the predetermined permissible difference, in other words until it is decided that there is no need to adjust the frame length.

In this example embodiment, as shown in the right-hand section of FIG. 4, it will be assumed that the delay time of the first delay time measurement frame is 3, the delay time of the second delay time measurement frame has become 3 through the adjustment, the delay time of the third delay time measurement frame has become 4 through the adjustment, the delay time of the fourth delay time measurement frame has become 3 through the adjustment, and the delay time of the fifth delay time measurement frame has become 2 through the adjustment.

As result, the maximum value of the difference in delay time after the adjustment according to step S111 of this example embodiment becomes 2, which is the difference between the delay time 4 of the third delay time measurement frame and the delay time 2 of the fifth delay time measurement frame, and thus the maximum difference becomes lower than the predetermined permissible difference in this example embodiment, which is 3 (N at step S110).

Then, the division and measurement unit 114 determines the length of the payload portions of the respective fragmentation signals, transmitted and received through the wireless transmission lines 130-1 to 130-5, so as to accord with the length of the payload portions of the first to the fifth delay time measurement frames after the adjustment (step S112), and finishes the process to determine the length of the payload portion of the fragmentation signal.

Note that the transmission rate of the wireless transmission line may vary, depending on environmental changes, such as the weather. In addition, the number of the wireless transmission lines may also vary, owing to malfunction of the modem or other components. Accordingly, to flexibly cope with such changes, it is preferable to transmit and receive the delay time measurement frames and measure the delay time, in a bandwidth that does not affect the transmission and reception of the main data, and adjust, if need be, the length of the payload portion of the fragmentation signal, according to the measurement result.

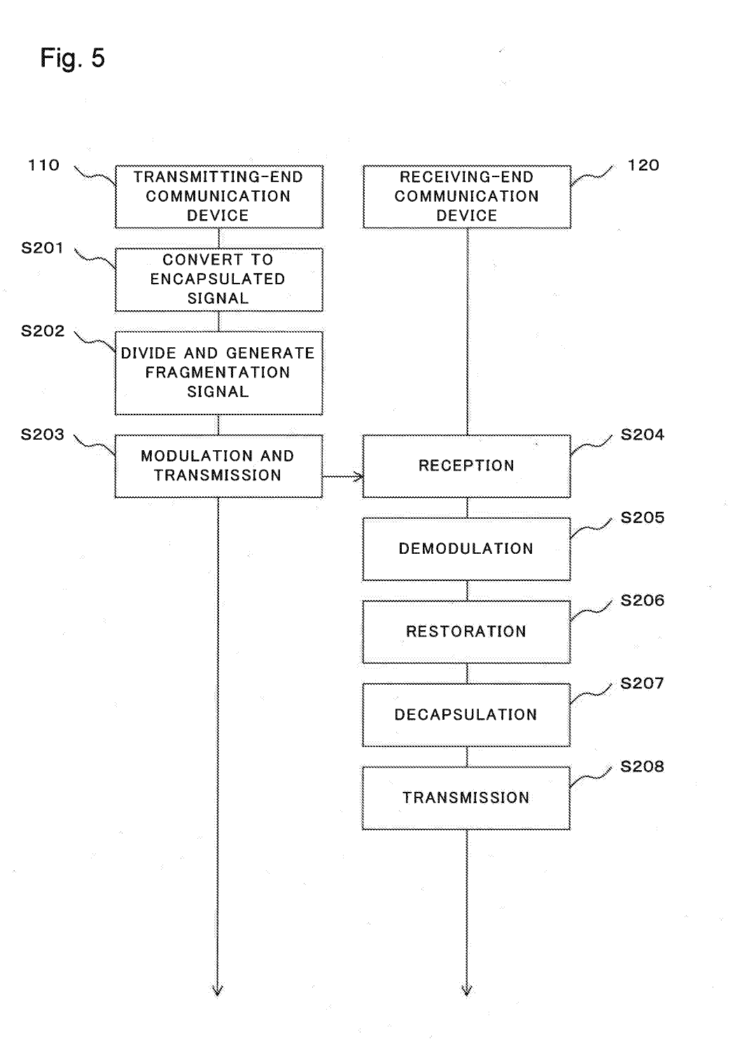

Hereunder, the transmission and reception of the wireless frame including the main data, through the wireless transmission lines 130-1 to 130-n, will be described. FIG. 5 is a sequence chart showing a transmission and reception process of the wireless frame between the transmitting-end communication device 110 and the receiving-end communication device 120. As shown in FIG. 5, transmitting-end the encapsulation block unit 112 of the communication device 110 converts the Ethernet signal inputted by the L2SW unit 111 into the encapsulated signal having the fixed length X (step S201).

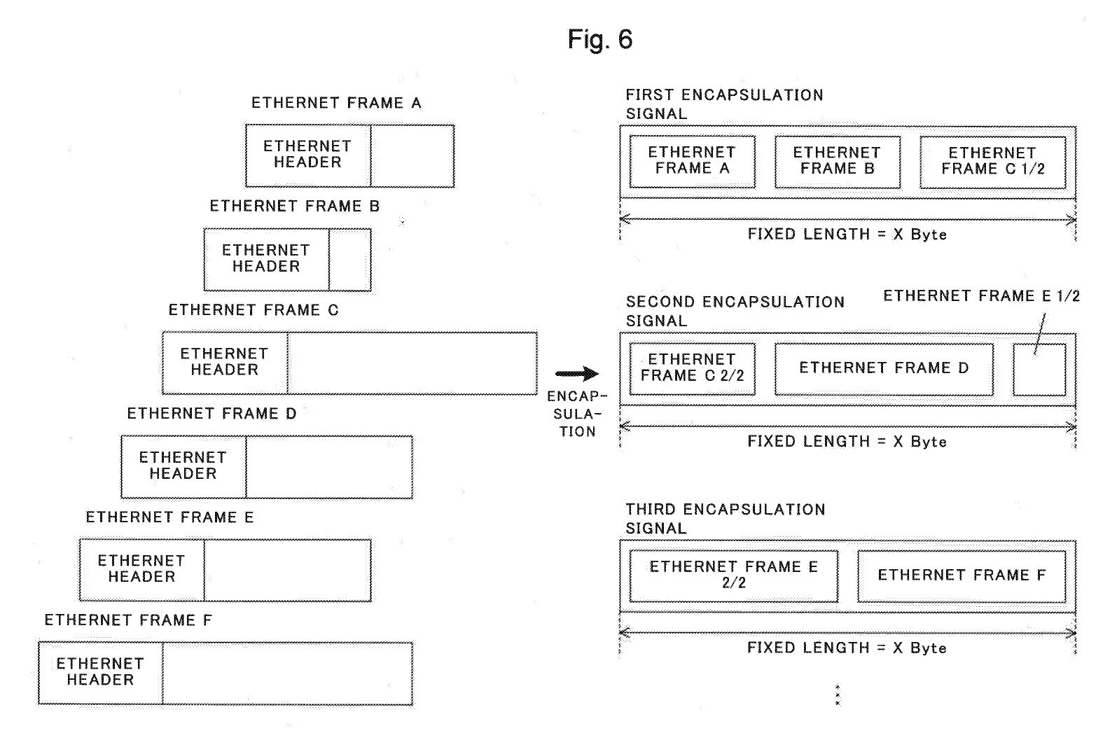

FIG. 6 is a schematic diagram for explaining a process of converting the Ethernet signal into the encapsulated signal, performed by the encapsulation block unit 112. As shown in FIG. 6, it will be assumed in this example embodiment that the L2SW unit 111 has sequentially inputted the Ethernet signals in the Ethernet frames A to F, different in frame length from one another, to the encapsulation block unit 112.

The encapsulation block unit 112 sequentially generates the encapsulated signals containing the Ethernet frames A to F, to convert the Ethernet signals to the encapsulated signals, such that the encapsulated signals have the fixed length X. Specifically, the encapsulation block unit 112 sequentially stores the Ethernet frames A to F, in one of the encapsulated signals. Then the encapsulation block unit 112 performs the following operation, in the case where the frame length of one encapsulated signal has reached the fixed length X, when a part of one Ethernet frame is stored in the one encapsulated signal. The encapsulation block unit 112 splits the one Ethernet frame, and stores the remainder of the one Ethernet frame in another encapsulated signal, to be transmitted so as to follow the one encapsulated signal.

In the example shown in FIG. 6, the Ethernet frames A and B, and a part of the Ethernet frame C are stored in a first encapsulated signal. In the example shown in FIG. 6, in addition, the remainder of the Ethernet frame C, the Ethernet frame D, and a part of the Ethernet frame E are stored in a second encapsulated signal, to be transmitted so as to follow the first encapsulated signal. Further, in the example shown in FIG. 6, the remainder of the Ethernet frame E and the Ethernet frame F are stored in a third encapsulated signal, to be transmitted so as to follow second encapsulated signal.

Then, the encapsulation block unit 112 inputs the encapsulated signals each containing the Ethernet signals, to the division and measurement unit 114.

Here, the Ethernet headers respectively included in the Ethernet frames A to F are stored in the encapsulated signals, as appropriate.

The division and measurement unit 114 divides the encapsulated signals inputted by the encapsulation block unit 112, and generates the fragmentation signals that respectively accord with the wireless transmission lines 130-1 to 130-n (step S202).

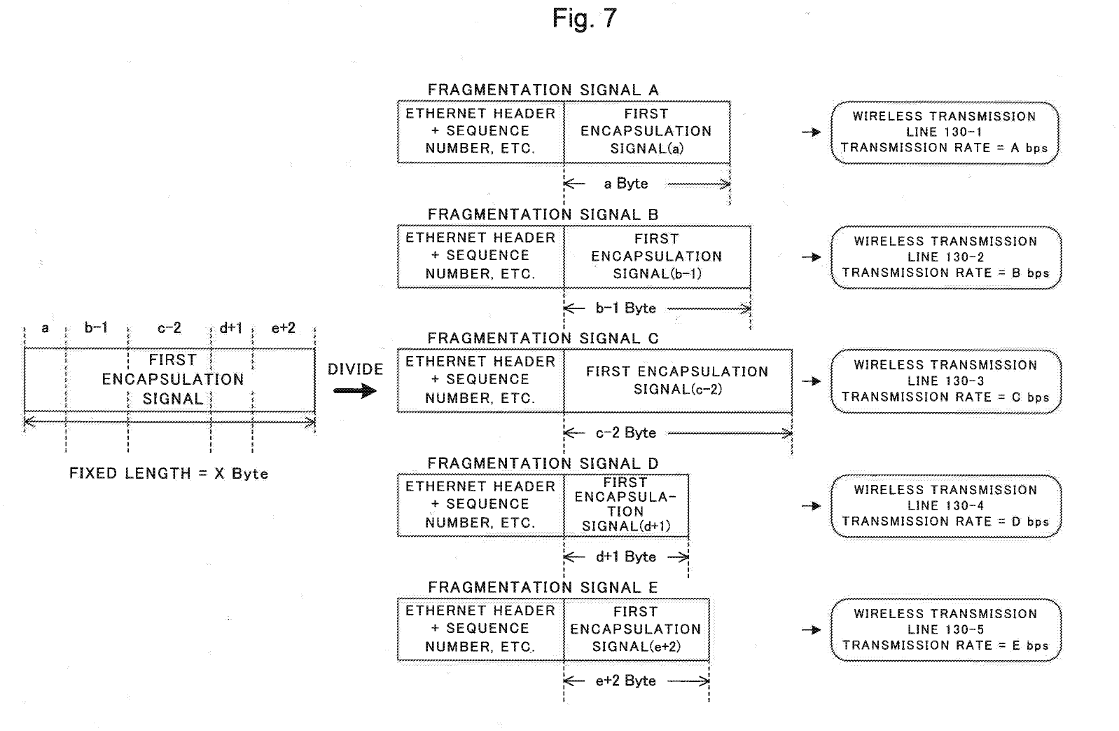

FIG. 7 is a schematic diagram for explaining a process of dividing the encapsulated signal to generate fragmentation signals, performed by the division and measurement unit 114. The division and measurement unit 114 divides the encapsulated signals inputted by the encapsulation block unit 112, into the lengths determined at step S112. In this example embodiment, as shown in FIG. 7, the division and measurement unit 114 divides the first encapsulated signal inputted by the encapsulation block unit 112 into blocks having the length of a Byte, b−1 Byte, c−2 Byte, d+1 Byte, and e+2 Byte, so as to accord with the wireless transmission lines 130-1 to 130-5. The division and measurement unit 114 also divides, as the first encapsulated signal, the second encapsulated signal and the third encapsulated signal inputted by the encapsulation block unit 112, into the blocks having the length of a Byte, b−1 Byte, c−2 Byte, d+1 Byte, and e+2 Byte, so as to accord with the wireless transmission lines 130-1 to 130-5.

In this example embodiment, the division and measurement unit 114 then stores the divided blocks in the payload portion, and stores the Ethernet header used for transmission and reception of the wireless frame, the sequence number according to the order of the transmission, and the number of divisions, in the header portion, to thereby generate the fragmentation signals that respectively accord with the wireless transmission lines 130-1 to 130-5.

In this example embodiment, the division and measurement unit 114 generates, as shown in FIG. 7, a fragmentation signal A in which the block of a Byte in the first encapsulated signal is stored in the payload portion, a fragmentation signal B in which the block of b−1 Byte in the first encapsulated signal is stored in the payload portion, a fragmentation signal C in which the block of c−2 Byte in the first encapsulated signal is stored in the payload portion, a fragmentation signal D in which the block of d+1 Byte in the first encapsulated signal is stored in the payload portion, and a fragmentation signal E in which the block of e+2 Byte in the first encapsulated signal is stored in the payload portion. Likewise, the division and measurement unit 114 generates the fragmentation signals A to E, on the basis of the second and third encapsulated signals.

The division and measurement unit 114 inputs the fragmentation signals generated as above, to the modems 115-1 to 115-n respectively corresponding to the wireless transmission lines 130-1 to 130-n (in this example embodiment, the modem 115-1 to 115-5 respectively corresponding to the wireless transmission lines 130-1 to 130-5).

The modems 115-1 to 115-n (in this example embodiment, modems 115-1 to 115-5) each transmit the wireless frame, modulated from the fragmentation signals inputted by the division and measurement unit 114 (step S203).

The modems 125-1 to 125-n of the receiving-end communication device 120 each receive the wireless frame modulated and transmitted by the corresponding one of the modems 115-1 to 115-n, through the wireless transmission lines 130-1 to 130-n (step S204). In this example embodiment, the modems 125-1 to 125-5 of the receiving-end communication device 120 each receive the wireless frame modulated and transmitted by the corresponding one of the modems 115-1 to 115-5, through the wireless transmission lines 130-1 to 130-5.

The modems 125-1 to 125-n each demodulate the wireless frame received through the corresponding one of the wireless transmission lines 130-1 to 130-n, into the fragmentation signal (step S205), and input the fragmentation signal to the restoration and measurement unit 124. In this example embodiment, the modem 125-1 to 125-5 each demodulate the wireless frame received through the corresponding one of the wireless transmission lines 130-1 to 130-5, and input the fragmentation signal demodulated from the wireless frame, to the restoration and measurement unit 124.

The restoration and measurement unit 124 restores the fragmentation signals respectively inputted by the modems 125-1 to 125-n (in this example embodiment, modems 125-1 to 125-5), to the encapsulated signals (step S206). Then the restoration and measurement unit 124 inputs the restored encapsulated signals to the decapsulation block unit 122.

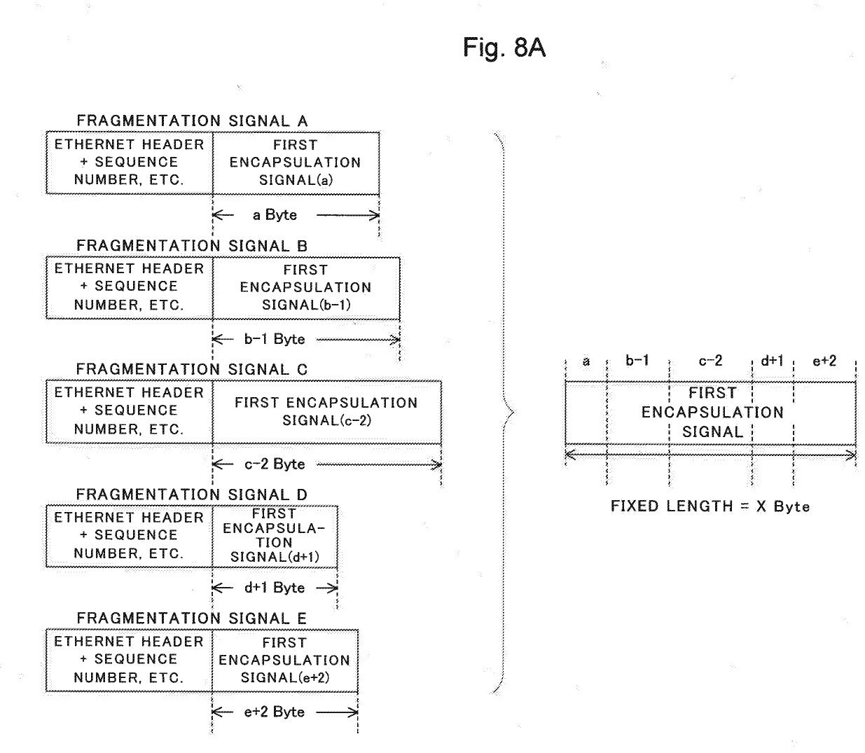

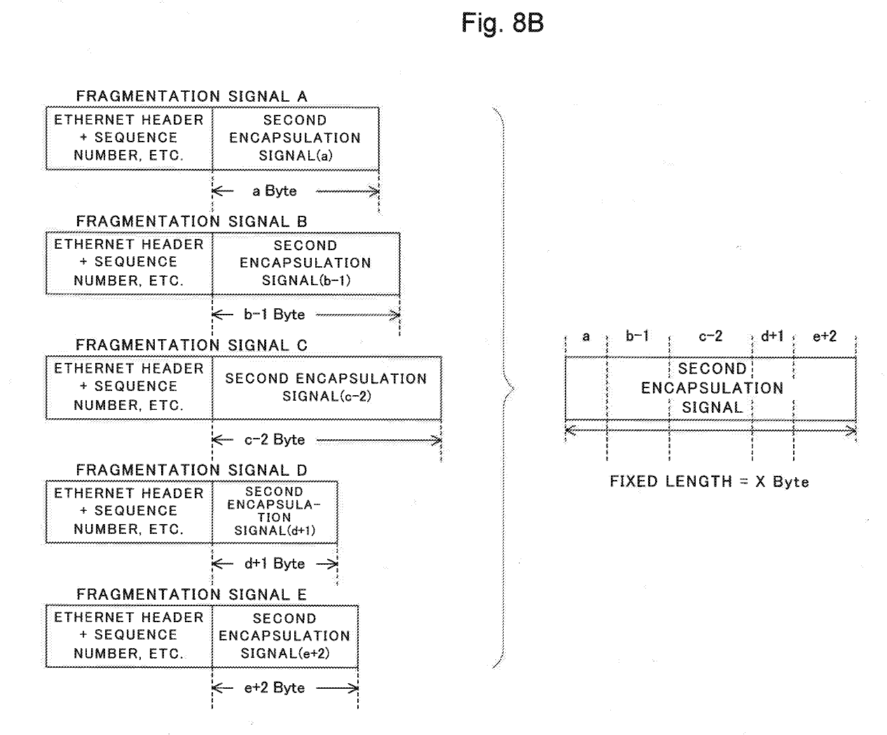

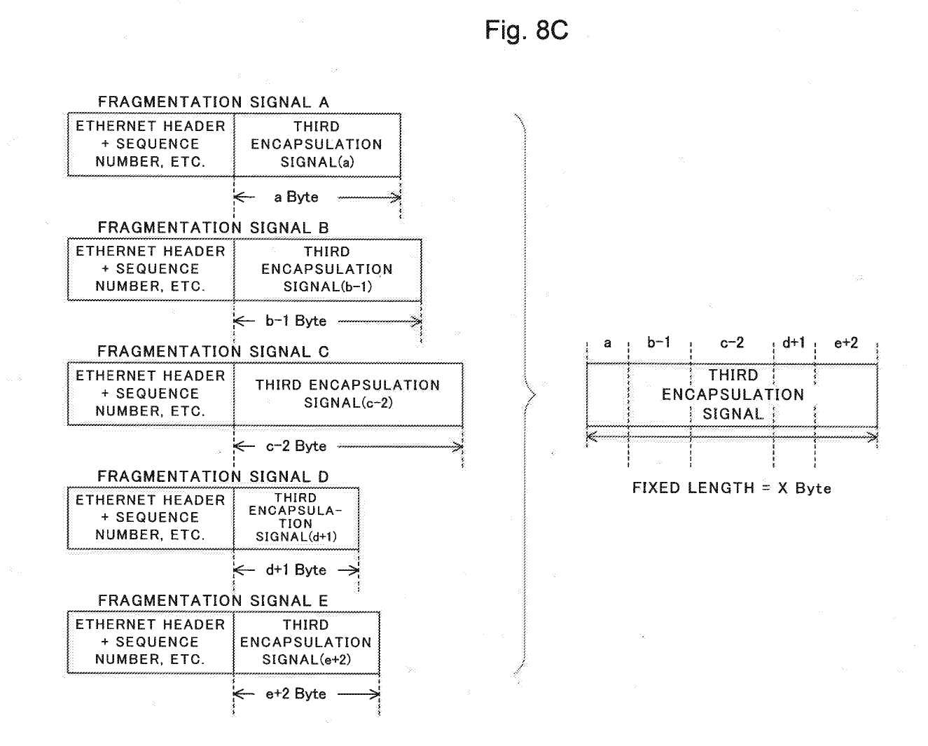

FIGS. 8A to 8C are schematic diagrams for explaining the process of restoring the encapsulated signal from the fragmentation signals.

In this example embodiment, as shown in FIGS. 8A to 8C, the restoration and measurement unit 124 restores the first to the third encapsulated signals, each including the blocks contained in the payload portion of the fragmentation signals A to E, according to the sequence number, the number of divisions, and so forth included in the header portion of the fragmentation signals. Then the restoration and measurement unit 124 inputs the first to the third encapsulated signals restored as above, to the decapsulation block unit 122.

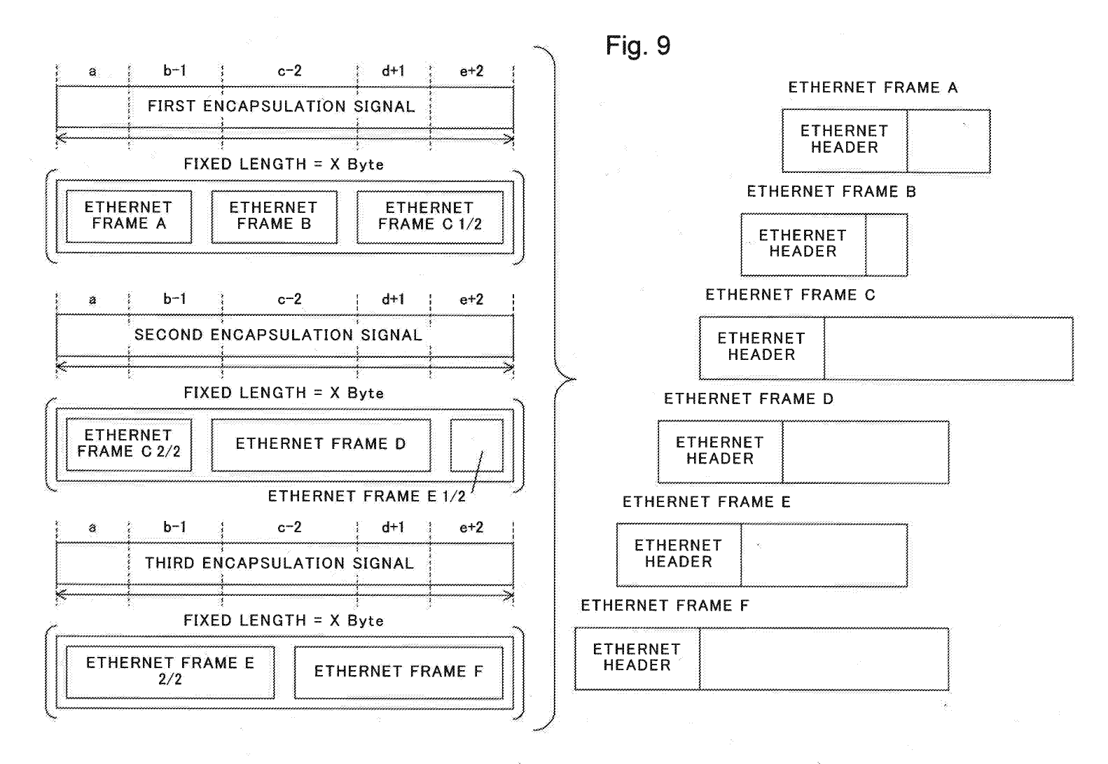

FIG. 9 is a schematic diagram for explaining a process of decapsulating the encapsulated signal into the Ethernet signal.

As shown in FIG. 9, the decapsulation block unit 122 decapsulates the first to the third encapsulated signals inputted by the restoration and measurement unit 124, into the Ethernet signals in the Ethernet frames A to F (step S207). Then the decapsulation block unit 122 inputs the decapsulated Ethernet signals to the L2SW unit 121.

The L2SW unit 121 transmits the Ethernet signals inputted by the decapsulation block unit 122, for example to a non-illustrated communication apparatus located outside the communication system 100 (step S208).

According to this example embodiment, the transmitting-end communication device 110 determines the frame length of the payload portion of the fragmentation signal, such that the difference in time that each of the delay time measurement frames reaches the receiving-end communication device 120 falls within the predetermined permissible difference, on the basis of the delay time of the wireless transmission lines 130-1 to 130-n, measured with the delay time measurement frame transmitted and received between the transmitting-end communication device 110 and the receiving-end communication device 120. Then, the transmitting-end communication device 110 transmits the wireless frame, modulated from the fragmentation signal generated by dividing the Ethernet signal into the length that accords with the frame length determined on the basis of the delay time. Accordingly, the difference in time that each of the fragmentation signals reaches the receiving-end communication device 120 can be made to fall within the predetermined permissible difference. Therefore, the receiving-end communication device 120 can properly restore the data, divided and transmitted by the transmitting-end communication device 110 and received through the wireless transmission lines 130-1 to 130-n independent from each other, into the original data without incurring an error. In addition, even though the communication volume increases between the receiving-end communication device 120 and the transmitting-end communication device 110, the increase of the delay time can be effectively suppressed.

Further, since the difference in time that each of the fragmentation signals reaches the receiving-end communication device 120 falls within the predetermined permissible difference in this example embodiment, the capacity of the buffer in the restoration and measurement unit 124 of the receiving-end communication device 120 can be reduced. Therefore, the hardware of the receiving-end communication device 120 can be simplified, and prepared at a lower cost.

Although the delay time measurement frame is employed to measure the delay time of the wireless transmission lines 130-1 to 130-n, a method based on a standardized protocol, such as the delay measurement (DM) of the Ethernet Operations, Administration, Maintenance (OAM), the precision time protocol (PTP) of the Institute of Electrical and Electronics Engineers, Inc. (IEEE) 1588, may be employed.

Further, the process from step S101 to step S111 is repeated in this example embodiment, so that the division and measurement unit 114 determines the frame length of the fragmentation signal. However, the division and measurement unit 114 may be configured to determine the frame length of the fragmentation signal, on the basis of the number provided by the division number setting information, the transmission rate indicated by the bandwidth information, the delay time obtained through the process of step S107, and the capacity of the buffer in the restoration and measurement unit 124 of the receiving-end communication device 120, instead of repeating the process from step S101 to step S111.

### Example Embodiment 2

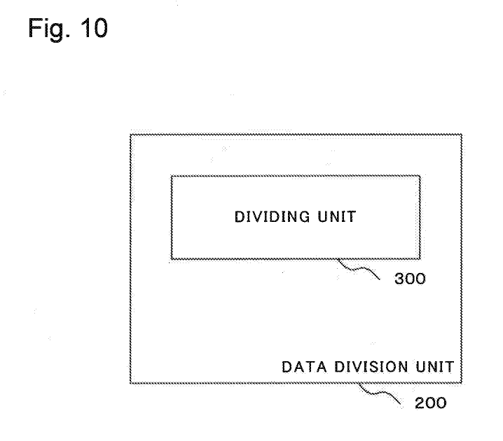

A second example embodiment of the present invention will be described, with reference to the drawing. FIG. 10 is a block diagram showing a configuration of a data division unit 200 according to the second example embodiment of the present invention. As shown in FIG. 10, the data division unit 200 according to the second example embodiment of the present invention includes a dividing unit 300 (corresponding to the division and measurement unit 114 shown in FIG. 1).

The dividing unit 300 divides the data, for each of a plurality of transmission lines parallel to each other (corresponding to the wireless transmission lines 130-1 to 130-n shown in FIG. 1), into divided data each having a length that accords with the delay time of the corresponding one of the plurality of transmission lines, and inputs the transmission data based on the divided data to the communication device (corresponding to the modems 115-1 to 115-n shown in FIG. 1) for transmission, so as to correspond to the transmission lines.

The configuration according to this example embodiment allows the receiving end to properly restore the data, divided and transmitted by the transmitting end and received through the transmission lines independent from each other, into the original data.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2015-157121, filed on Aug. 7, 2015, the disclosure of which is incorporated herein in its entirety by reference.

### REFERENCE SIGNS LIST

100 communication system
110 transmitting-end communication device
111, 121 L2SW unit
112 encapsulation block unit
113 apparatus setting unit
114 division and measurement unit
115-1 to 115-n, 125-1 to 125-n modem
120 receiving-end communication device
122 decapsulation block unit
124 restoration and measurement unit
200 data division unit
300 dividing unit

1. A data division unit comprising a dividing unit that divides data, for each of a plurality of transmission lines parallel to each other, into divided data each having a length determined according to a delay time of a corresponding one of the plurality of transmission lines, and inputs transmission data based on the divided data to a communication unit for transmission, so as to correspond to the transmission lines.

2. The data division unit according to claim 1,
wherein the dividing unit inputs the divided data to which a receiving-end apparatus has added information that allows the data to be restored, to the communication unit.

3. The data division unit according to claim 1,
wherein the dividing unit:
generates a delay time measurement frame to be transmitted and received to and from the receiving-end apparatus through the communication unit, to measure the delay time of each of the plurality of transmission lines, and inputs the delay time measurement frame to the communication unit; and
measures the delay time of each of the plurality of transmission lines, on a basis of a transmission timing and a reception timing of the delay time measurement frame.

4. The data division unit according to claim 1,
wherein the dividing unit inputs, to the communication unit, the divided data, divided into a length that accords with the delay time of the plurality of transmission lines, such that a difference in timing that the receiving-end apparatus receives each of the transmission data transmitted by the communication unit through a corresponding one of the plurality of transmission lines falls within a predetermined time difference.

5. A communication device comprising:
the data division unit according to claim 1; and
the communication unit.

6. A communication system comprising:
the communication device according to claim 5; and
the receiving-end apparatus,
wherein the receiving-end apparatus includes:
a receiving unit that receives transmission data transmitted by the communication unit; and
a restoring unit that restores the transmission data received by the receiving unit, into the data.

7. A data division method comprising:
dividing data, for each of a plurality of transmission lines parallel to each other, into divided data each having a length determined according to a delay time of a corresponding one of the plurality of transmission lines; and
inputting transmission data based on the divided data to a communication unit for transmission, so as to correspond to the transmission lines.

8. A storage medium comprising a data division program for causing a computer to:
divide data, for each of a plurality of transmission lines parallel to each other, into divided data each having a length determined according to a delay time of a corresponding one of the plurality of transmission lines; and
input transmission data based on the divided data to a communication unit for transmission, so as to correspond to the transmission lines.
